(19) United States
(12) Patent Application Publication
(10) Pub. No.: US 2026/0141677 A1
(43) Pub. Date: May 21, 2026

(54) METHOD AND DEVICE WITH IMAGE PROCESSING AND TARGET DETECTION

(71) Applicant: SAMSUNG ELECTRONICS CO., LTD., Suwon-si (KR)

(72) Inventors: Kai WANG, Xi’an (CN); Rong ZHANG, Xi’an (CN); Seungju HAN, Suwon-si (KR)

(73) Assignee: SAMSUNG ELECTRONICS CO., LTD., Suwon-si (KR)

(21) Appl. No.: 19/395,027

(22) Filed: Nov. 20, 2025

(30) Foreign Application Priority Data
Nov. 20, 2024 (CN) 202411669568.2
Oct. 28, 2025 (KR) 10-2025-0157822

(51) Int. Cl. G06V 10/74; G06V 10/77; G06V 20/40

(52) U.S. Cl. CPC G06V 10/761; G06V 10/7715; G06V 20/46; G06V 2201/07

(57) ABSTRACT

An image processing method and a device, and an object detection method and a device are provided. The image processing method comprises: acquiring an input image; determining a first similarity between the input image and a preset first background template; determining a background template for the input image based on the first similarity; extracting a foreground image from the input image based on the background template for the input image. The target detection method comprises: acquiring a video including a plurality of input images; for the plurality of input images, sequentially performing the image processing method as described above; by using a target detection model, performing target detection on the foreground image obtained by the image processing method.

### CROSS-REFERENCE TO RELATED APPLICATIONS

This application claims the benefit under 35 USC § 119(a) of Chinese Patent Application No. 202411669568.2, filed on November 20, 2024, in the China National Intellectual Property Administration and Korean Patent Application No. 10-2025-0157822 filed in the Korean Intellectual Property Office on October 28, 2025, the entire disclosure of which is incorporated herein by reference for all purposes.

### BACKGROUND

### FIELD

The material described herein relates to the field of computer vision, specifically, to a method and a device with target detection.

### DESCRIPTION OF RELATED ART

With the development of computer vision technology, image processing based on vision technology is increasingly utilized for image detection and recognition. However, related image processing methods are usually unable to simultaneously provide high accuracy and low latency when detecting and recognizing a target object.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments provide an image processing method and a device, and a target detection method and a device that may address some of the above problems and/or drawbacks.

In one general aspect, a method for image processing is performed by one or more processors and includes: acquiring an input image; determining a first similarity between the input image and a preset first background template; determining a background template for the input image based on the first similarity; and extracting a foreground image from the input image based on the background template for the input image.

The determining the background template for the input image based on the first similarity may include, based on comparing the first similarity to a first threshold, selecting between: when the first similarity is greater than or equal to a first threshold, determining the first background template as the background template for the input image; and when the first similarity is less than the first threshold, determining the background template for the input image according to the input image and the first background template.

Based on the first similarity being less than the first threshold, the determining the background template for the input image according to the input image and the first background template may include: aligning the first background template with the input image, to obtain an second background template; determining a second similarity between the input image and the second background template, and based thereon selecting between: when the second similarity is greater than or equal to a second threshold, updating the first background template according to the input image, and determining the updated first background template as the background template for the input image; and when the second similarity is less than the second threshold, generating the background template for the input image according to the input image .

Based on the second similarity being greater than or equal to the second threshold, the updating the first background template according to the input image may include: obtaining a background area of the input image by segmenting the input image using a segmentation model; and filling a portion of an area-to-be-filled included in the second background template based on the background area, to obtain the updated first background template.

The filling the portion of the area-to-be-filled included in the second background template based on the background area, to obtain the updated first background template, may include: determining an overlap area between the background area and the area-to-be-filled in the second background template; filling at least a portion of the overlap area in the second background template based on a portion corresponding to the overlap area in the input image; and determining the second background template of which the at least a portion of the overlap area is filled, as the updated first background template.

The generating the background template for the input image according to the input image may include, based on the second similarity being less than the second threshold: obtaining a non-background area of the input image by segmenting the input image using a segmentation model; setting the non-background area in the input image as an area-to-be-filled; and determining the input image of which the area-to-be-filled is set, as the background template for the input image.

The extracting the foreground image from the input image based on the background template for the input image may include: obtaining a difference image of the input image based a difference between the input image and the background template; obtaining a mask image based on values of respective pixels in the difference image; and obtaining the foreground image based on the input image and the mask image.

The background template for the input image may include a first area-to-be-filled for extracting the foreground image, wherein a first image feature of the first area is set based on an occurrence frequency of the first image feature and the first image feature is different from a second image feature of a second area in the background template other than the first area.

In another general aspect, a target detection is method performed by one or more processors, and the method includes: acquiring a video including input images; determining first similarities between the input images and respective preset first background templates; determining background templates for the respective input images based on the respective first similarities; extracting foreground images from the respective input images based on the respective background templates for the respective input images; and using a target detection model to perform target detection on the extracted foreground images.

In another general aspect, a device for image processing includes: one or more processors including processing circuitry; and one or more memories storing code or instructions configured to, when executed by the one or more processors, cause the device to: acquire an input image; determine a first similarity between the input image and a preset first background template; determine a background template for the input image based on the first similarity; and extract a foreground image from the input image based on the background template for the input image.

The determining the background template for the input image based on the first similarity may be performed by, based on comparing the first similarity to a first threshold, selecting between: when the first similarity is greater than or equal to a first threshold, determining the first background template as the background template for the input image; and when the first similarity is less than the first threshold, determining the background template for the input image according to the input image and the first background template.

The instructions or code may be further configured to cause the device to, based on the first similarity being less than the first threshold, determine the background template for the input image according to the input image and the first background template by: aligning the first background template with the input image, to obtain an second background template; determining a second similarity between the input image and the second background template, and based thereon selecting between: when the second similarity is greater than or equal to a second threshold, updating the first background template according to the input image, and determining the updated first background template as the background template for the input image; and when the second similarity is less than the second threshold, generating the background template for the input image according to the input image.

The instructions or code may be configured to cause the device to, based on the second similarity being greater than or equal to the second threshold, update the first background template according to the input image by: obtaining a background area of the input image by segmenting the input image using a segmentation model; and filling a portion of an area-to-be-filled included in the second background template based on the background area, to obtain the updated first background template.

The instructions or code may be further configured to cause the device to fill the portion of the area-to-be-filled included in the second background template based on the background area, and obtain the updated first background template, by: determining an overlap area between the background area and the area-to-be-filled in the second background template; filling at least a portion of the overlap area included in the second background template based on a portion corresponding to the overlap area in the input image; and determining the second background template of which the at least a portion of the overlap area is filled, as the updated first background template.

The instructions or code may be further configured to, based on the second similarity being less than the second threshold, generate the background template for the input image according to the input image, by: obtaining a non-background area of the input image by segmenting the input image using a segmentation model; setting the non-background area in the input image as an area-to-be-filled; and determining the input image of which the area-to-be-filled is set, as the background template for the input image.

The instructions or code may be further configured to cause the device to extract the foreground image from the input image based on the background template for the input image by: obtaining a difference image of the input image based on a difference between the input image and the background template; obtaining a mask image based on values of respective each pixels in the difference image; and obtaining the foreground image based on the input image and the mask image.

The background template for the input image may include a first area-to-be-filled for extracting the foreground image, and a first image feature of the first area may be set based on an occurrence frequency of the first image feature that is different from a second image feature of a second area in the background template other than the first area.

Other features and aspects will be apparent from the following detailed description, the drawings, and the claims.

### BRIEF DESCRIPTION OF THE DRAWINGS

The above and other aspects, features and elements of certain embodiments will become more apparent by the following descriptions in conjunction with the accompanying drawings, in which:

FIG. 1 illustrates an image processing method according to some embodiments;

FIG. 2 illustrates an example image processing method according to some embodiments;

FIG. 3 illustrates an example of updating a background template according to some embodiments;

FIG. 4 illustrates an example of generating a background template according to some embodiments;

FIG. 5 illustrates an example of extracting a foreground image according to some embodiments;

FIG. 6 illustrates a target detection method according to some embodiments;

### 0031] FIG. 7 illustrates structure of an image processing device according to some embodiments

FIG. 8 illustrates structure of a target detection device according to some embodiments; and

FIG. 9 illustrates structure of an electronic apparatus according to some embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles "a," "an," and "the" are intended to include the plural forms as well, unless the context clearly indicates otherwise. As used herein, the term "and/or" includes any one and any combination of any two or more of the associated listed items. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being "connected to," "coupled to," or "joined to" another component or element, it may be directly "connected to," "coupled to," or "joined to" the other component or element, or there may reasonably be one or more other components or elements intervening therebetween. When a component or element is described as being "directly connected to," "directly coupled to," or "directly joined to" another component or element, there can be no other elements intervening therebetween. Likewise, expressions, for example, "between" and "immediately between" and "adjacent to" and "immediately adjacent to" may also be construed as described in the foregoing.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term "may" herein with respect to an example or embodiment, e.g., as to what an example or embodiment may include or implement, means that at least one example or embodiment exists where such a feature is included or implemented, while all examples are not limited thereto.

In the related art, in order to process a video or an image, a single general model is typically used to perform an image processing operation regarding a target object, for example, a general target detection model is typically used to perform detection and recognition of the target object. However, for image processing multiple images using the single general model (e.g., the general target detection model), high accuracy in model calculation results and low latency during the use of the model are usually mutually exclusive. Specifically, when using a large-scale model for the image processing, a technology that uses a large-scale model to process multiple input images, despite having a high accuracy in detection results, has a high latency and requires a large amount of computational resources and storage space. On the other hand, although a technology using a light-weight model is more friendly to computational resources and storage space, and can reduce the latency, the accuracy of its detection or recognition result is usually low compared to a large-scale model.

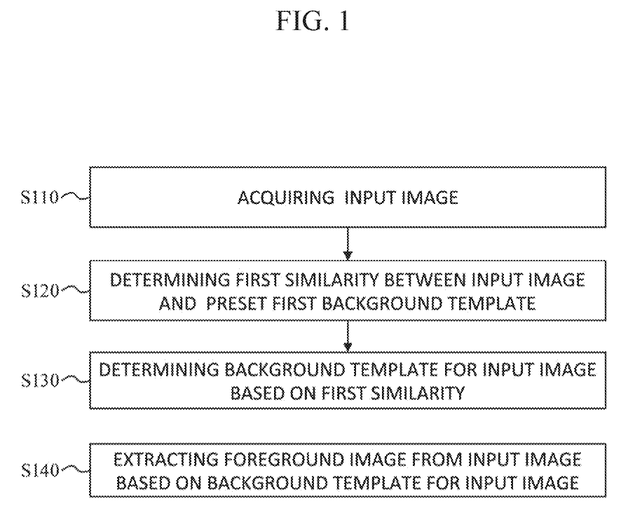

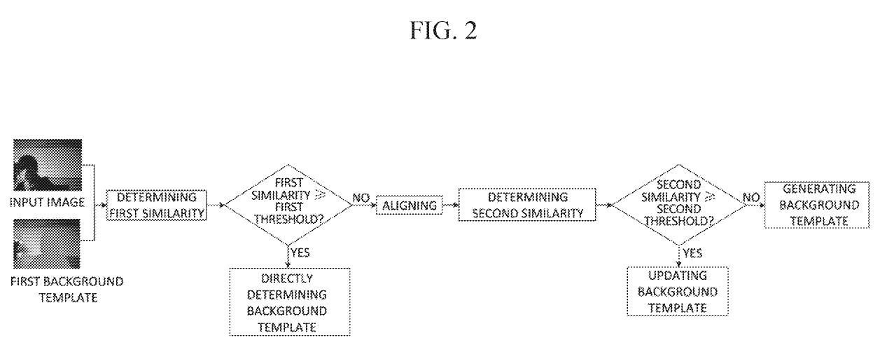

Considering at least the above problems of the related art, an image processing method and device may determine a background template suitable for an input video or image and may perform foreground extraction based on the background template to obtain a foreground image containing a target object. The foreground extraction processing can enable an optimal balance of the accuracy and the latency of the image processing with respect to the target object. In addition, since the foreground image containing the target object has been obtained based on the above image processing method (i.e., since the foreground image is generally smaller than the overall image), target detection may be performed on the foreground image by using a light-weight target detection model, so that an accurate target detection result can be obtained without using a large-scale model. The image processing method and device and the target detection method and a device according to some embodiments are described with reference to FIGS. 1 to 9.

Some of terms used herein are defined next.

A foreground (which may also be referred to as a foreground portion or a foreground area) may include a portion of an image that is associated with a target object, and a background (which may also be referred to as a background portion or a background area) may include a portion of the image that is not associated with the target object or is not associated with image analysis processing.

A foreground image be an image that includes the foreground and an area-to-be-filled, which may be obtained by performing foreground extraction on the image. Here, the foreground extraction may divide the foreground from the background in the image or separate the foreground from non-foreground (background) parts of the image.

An object included in a foreground may be in motion or stationary, and similarly, an object included in a background may be in motion or stationary. That is, the distinction regarding the foreground and the background is independent of a motion state of one or more objects in the image, and the foreground is relatively independent of the background. For example, in an indoor scene, when target objects are both a person and a camera, the foreground may be a portion of the captured video or image that includes a moving person and a stationary camera.

As another example, in a highway scene, when the target object is a car, the foreground may be a portion of the captured video or image that includes a moving car and a stopped car.

A large-scale (target detection) model includes a model that uses relatively large-scale model parameters, characterized by the use of more computational resources and storage space, high latency, high accuracy, and so on.

A light-weight (target detection) model includes a model that uses relatively small-scale model parameters, characterized by being friendlier to the storage and computation, less latency, low accuracy, and so on. Generally, "light-weight" and "large-scale" are relative terms; what is significant is that a light-weight model is appreciably smaller (and less compute-intensive) than a large-scale model.

FIG. 1 illustrates an image processing method according to some embodiments. and FIG. 2 illustrates an example image processing method according to some embodiments.

Referring to FIG. 1, at step S110, an input image is acquired. For example, referring to FIG. 2, an input image containing a person and a background in an indoor scene is acquired.

The manner of acquiring the input image may involve, but is not limited to, receiving an input image (e.g., receiving image data), capturing an input image (capturing an input image using a video or image capture apparatus (e.g., a camera)), reading an input image (e.g., reading an input image from a memory), performing image pre-processing on an arbitrary image to generate the input image, or the like.

According to some embodiments, in a case where a video is acquired, at least one input image may be acquired from the video at predetermined intervals. For example, the at least one video frame may be determined/selected from among multiple video frames at intervals of a predetermined number of frames, and each such selected video frame is used as the input image, successively. That is to say, in a case where images in a video are acquired, each of the acquired images may be determined/used as an input image, respectively.

At step S120, a first similarity between the input image and a preset first background template is determined (here, "preset" means that the first background image exists prior to performing the step S120). Here, the input image and the first background template may have the same or substantially same dimensions, or, either or both may be scaled to have the same dimensions. Here, although the set shape contour is determined by the shape-contour occurrence frequency in an expected/normal scene, the set shape contour may be determined based on other appropriate manners, preferably such that the shape contour can enable the shape contour of the area-to-be-filled to be distinguished from the shape contour of the area in the background template other than the area-to-be-filled and/or other than the shape contour of the input image.

Background templates are described next, details of the discussed example background template may be applicable to other background templates (e.g., a first background template, a second background template, etc.). That is, the background templates in some embodiments may have the same or similar functionality or features, and the embodiments are not limited thereto.

According to some embodiments, a background template (e.g., the first background template) for extracting a foreground image in an image processing situation may be preset. For example, a background template determined based on experience or tests performed in various scenarios may be preset as the preset background template.

For example, a scene (e.g., a scene category) to which the input image belongs may be identified and a background template may be obtained and preset based on the identified scene. For example, referring to FIG. 2, the scene of the input image of FIG. 2 may be identified (e.g., through metadata, image processing, etc.) as an "indoor scene" category and a scene template corresponding to the "indoor scene" category may, based on an association with the "indoor scene" category, be determined/set as the preset background template.

As another example, an image containing a predetermined image feature may be preset/selected as a preset background template on the basis of its image feature. For example, the image feature may be a color feature, a texture feature, and/or a shape feature, but is not limited thereto. The image may be selected as the background template based on its image feature matching a feature associated with the input image.

For example, an image containing a predetermined color (e.g., a pure-color image having only a single color) may be set as the preset background template. As another example, an image containing a predetermined texture (e.g., a striped image having only regular stripes) determined to correspond to the input image may be set as the preset background template. As another example, an image containing a predetermined shape contour (e.g., an image having a human-shaped contour) determined to correspond to the input image may be set as the preset background template.

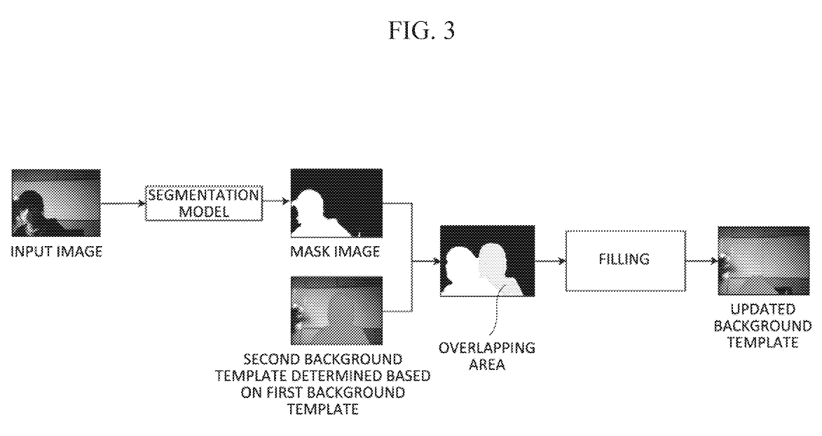

Furthermore, the background template may include an area-to-be-filled that, as will be described, is later to be used for extracting a foreground image (e.g., an area of non-background). For an example of the area-to-be-filled, see the "AREA TO BE FILLED" (human shape) shown in FIGS. 2 and 3. For example, the area-to-be-filled may be an area of image data of a foreground object, e.g., an object being subjected to image processing (e.g., object

identification). An image feature of the area-to-be-filled may be set based on an occurrence frequency of the image feature (e.g., a feature with the highest occurrence frequency); the determinative image feature may be different from an image feature of an area in the background template (which is not in the area-to-be-filled).

For example, when the set image feature is a color feature, the occurrence frequency of the image feature may be a color occurrence frequency (e.g., a ratio of pixels having the color (or having a similar color)), and thus a color of the area-to-be-filled in the background template may include a color determined based on the color occurrence frequency (such as, a color that occurs less frequently or infrequently in nature), and which is substantially different from colors in all of the other areas in the background template (i.e., the area may be one determined to be unique, i.e., there are no other areas with its feature color).

An object having certain pure colors (e.g., purpose or close to purple) is less likely to exist in nature or in a usual scene. An error in the image processing due to the presence of a color in the input image that is the same as (or close to) that of the area-to-be-filled (and/or the area-to-be-filled being of the same color as the remaining area in the background template) may be avoided, for example, by setting the area-to-be-filled in the background template to a less likely color, e.g., that has a low occurrence frequency, possibly for the context of the input image (e.g., purple).

Here, although this artificially-set color is determined considering general color occurrence frequency in nature or in a usual scene (e.g., relative to the input image), the set color may be determined based on other means, preferably if this to-be-set color allows the color of the area-to-be-filled to be (i) distinguished from the color of an area of the background template that is an aera other than the area-to-be-filled and/or (ii) distinguished from the color in the input image. For example, the color-to-be-set me be determined based on a color determined with respect to a color included in one or more input images (e.g., when the input image includes a red color, the set color should not include the red color or a color that is substantially close to red (e.g., within a threshold difference)). As another example, the set color may be a color determined based on the identified scene category of the input image, etc. (e.g., when the scene of the input image is an outdoor scene at night, this set color should not include black or a color substantially close to black, and may be, for example, white). In brief, the color-to-be-set may be selected to allow the area-to-be-filled to be uniquely identified by color, with respect to the input image(s).

For example, when the set image feature is a texture feature, the occurrence frequency of the image feature may be a texture occurrence frequency, and thus, a texture of the area-to-be-filled in the background template may include a texture determined based on the texture occurrence frequency (e.g., a texture that occurs less frequently or infrequently in nature (e.g., a regular linear texture, a regular point texture, etc.)), and which is different from textures in the other areas of the background template (and, depending on implementation, different than texture(s) in the input image(s)).

Here, although the texture is determined considering the texture occurrence frequency in nature or in a usual/expected scene (e.g., a scene category associated with the input image(s)), the set texture may also be a texture determined based on other appropriate manners, as long as the texture allows the texture of the area-to-be-filled to be distinguished from the texture in the area of the background template other than the area-to-be-filled and/or the texture in the input image. For example, the set texture may be a texture determined with respect to a texture included in one or more input images (e.g., when the input image includes a wallpaper pattern, the set texture should not include a texture associated with the wallpaper pattern). As another example, the set texture may be a texture determined based on the identified scene of the input image, etc. (e.g., when the scene of the input image is an indoor scene, the set texture should not include a texture associated therewith, e.g., a floor pattern, a wallpaper pattern, etc.). It may be assumed that, depending on implementation, information about the input image(s) or the image processing (e.g., a scene category, features of the same, etc.) may be stored in memory and referred to when selecting a background template.

As another example, when the set image feature is a shape feature, the occurrence frequency of the image feature may be a shape-contour occurrence frequency, and thus, a shape contour of the area-to-be-filled in the background template may include a shape contour determined based on the shape-contour occurrence frequency (e.g., more often, target detection processing has a person as a detection target, and thus, the person-shaped contour may be determined as the set shape contour), and the shape contour is different from shape contours in the other areas of the background template.

In addition, although the above description discusses a single image feature, the set image feature may include multiple features, e.g., color feature(s), texture feature(s), and/or shape feature(s). For example, the area-to-be-filled of the background template may have a set shape contour and color, e.g., with reference to FIG. 2, the area-to-be-filled in the first background template has a human-shaped contour feature and a single gray color feature, either or both of which may serve as the set feature(s).

The foreground image can be extracted from the input image by using the background template in which the area-to-be-filled with the set image feature has been set. A detailed description of the use of the background template is continued below with reference to FIG. 2.

According to some embodiments, the first similarity may represent an image similarity between the input image and the first background template. A metric for measuring the image similarity may include, but is not limited to, a Structural Similarity (SSIM), a Root Mean Squared Error (RMSE) of image pixel values, a Mean Squared Error (MSE) of image pixel values, a Universal Quality Index (UQI) of the image, a Scale Invariant Feature Transform (SIFT), a Deep Learning algorithm, etc.

Referring to FIG. 2, according to some embodiments, the first similarity may be determined using the SSIM algorithm, and the determined first similarity may be compared with a first threshold, to determine/select the first background template as the background template for the input image. In some implementations, the similarity-computing may be performed between the input image and other first background templates and the first background template with the highest similarity score may be selected as the background template for the input image. Here, the first similarity may also be a similarity determined in the manner described above or in any other metric; the processing for determining the similarity may be implemented in any appropriate manner (see the examples listed above).

Referring back to FIG. 1, at step S130, a background template for the input image may be determined/selected based on its first similarity with the input image. Specifically, with reference to FIG. 2, the first similarity may be compared to the first threshold value.. The first similarity may be used to determine whether to use the first background template directly or to instead update or generate the background template (e.g., one previously selected/determined) for the input image based on the input image and/or the first background template.

According to some embodiments, the first threshold may be a preset empirical value. When the similarity is greater than or equal to the first threshold, it can be considered as a high similarity; when the similarity is less than the first threshold, it can be considered as a low similarity. For example, the first threshold may be set to 0.65.

According to some embodiments, based on the first similarity being greater than or equal to a first threshold, the first background template is determined as the background template for the input image. Specifically, when the first similarity is high, it is considered that the input image conforms to the first background template or the first background template is applicable to the input image, and thus, the first background template may be directly used as the background template for the input image.

According to some embodiments, based on the first similarity being less than the first threshold, the background template for the input image is determined according to the input image and the first background template. Specifically, when the first similarity is less than the first threshold, although it may not be possible to extract the foreground image directly using the first background template, it is considered that there may be a bias or interference in acquiring the input image (e.g., capturing the image) causing the current first background template not to be applicable to (i.e., to be dissimilar to) the input image, whereas the first background template may in fact be applicable to the input image after a minor adjustment. In such a case, in order to save computational resources and time (e.g., to avoid an unnecessary step of generating a new background template), it is further determined whether to update the first background template to determine the background template for the input image or to instead generate a new background template for the input image.

For example, referring to FIG. 2, the minor adjustment of the first background template may be achieved by an alignment processing applied thereto. According to some embodiments, based on the first similarity being less than a first threshold, the first background template is aligned with the input image, to obtain an aligned second background template. The aligning the first background template with the input image with may include: aligning the first background template with the input image with based on local features of the input image and respectively corresponding local features of the first background template, such that the local features of both match after the aligning. Alignment may also involve an affine transform of the first background template (e.g., to cause the area-to-be-filled to more closely match or coincide with an object/area in the input image). It is also possible to subject the input image to the alignment process rather than the first background template.

According to some embodiments, the local features may be detectable at different scales and/or rotation angles, such as including, but not limited to, a corner point, an edge, and any other features composed of key points in the images and feature descriptors of related regions thereof. For example, multiple corner points having corresponding relationships in the input image and the first background template may be determined, respectively, and the first background template may be aligned with the input image such that the corner points having the corresponding relationships coincide in the aligned images, thereby causing the input image and the first background template to effectively reflect the same viewing angle. Other types of local features may be similarly aligned.

After the alignment processing is performed, the step of determining the similarity by comparison with a threshold value may be performed again. According to some embodiments, a second similarity between the input image and the second background template (e.g., one that has been transformed for alignment) is determined (similarity may be determined as described above). In addition, the second similarity may be measured in the same manner or differently than the first similarity, i.e., the second similarity computed using SSIM may be determined, or the second similarity, of which a type is different from a type of the first similarity, may be determined using other means.

Based on the second similarity being greater than or equal to a second threshold, the first background template may be updated according to the input image, and the updated first background template is determined as the background template for the input image. That is, when the second similarity is high, it may mean that the background template alignment provided sufficient similarity, and consequently: the background template may be updated and the updated background template may be used. The updating the background template is described with reference to FIG. 3.

FIG. 3 illustrates an example of updating a background template according to some embodiments.

According to some embodiments, a background area of the input image is obtained by segmenting the input image using a segmentation model (e.g., an instance segmentation model).

For example, an instance segmentation model may be used to identify, in the input image, (i) a target object area (or a mask area) associated with a target object (e.g., a person in the input image in FIG. 3) and (ii) a background area unrelated to the target object. A corresponding mask image may be determined based on the segmented target object area and background area of the input image, for example, in the example mask image shown in FIG. 3, the black area indicates the background area and the white area indicates the target object area.

According to some embodiments, when the background area in the input image has been determined, at least a portion of an area-to-be-filled in the second background template is filled based on the background area, to obtain the updated first background template. That is, the updating the first background template may include aligning the first background template to the input image, and may further include additional updating of the first background template after the alignment (thus producing the second background template).

According to some embodiments, the filling the portion of the area-to-be-filled in the second background template (such filling based on the background area) to obtain the updated first background template may include: determining an overlapping area between the background area and the area-to-be-filled in the second background template; filling the overlapping area in the second background template based on the overlapping area in the input image; and determining the second background template of which the overlapping area is filled, as the updated first background template

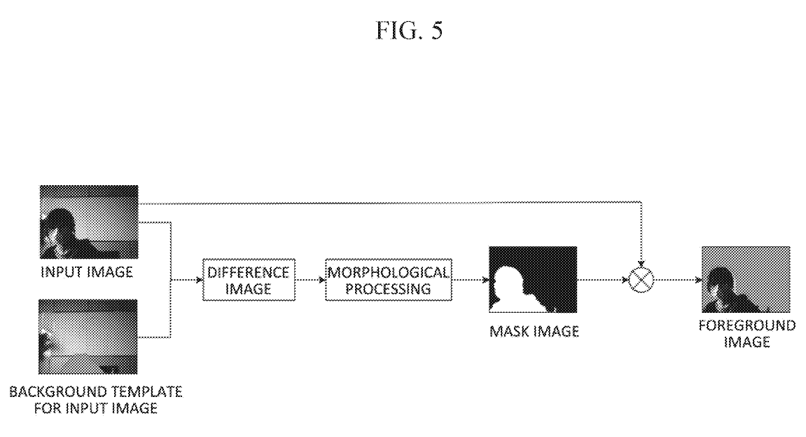

For example, with reference to FIG. 3, the image processing may determine an overlap area (intersection) between (i) the background area of the mask image (the black portion in the mask image in FIG. 3) and (ii) the area-to-be-filled (the single gray portion in the second background template in FIG. 3) in the current background template (e.g., the second background template). That is, in the area-to-be-filled of the second background template, the part of the second background template that corresponds to the above-mentioned overlap area may be filled with image data of the input image that corresponds to the overlap area. Put another way, an updated background template may be obtained by filling a portion thereof corresponding to the overlap area based on a portion in the input image that corresponds to the overlapping area. To elaborate further, as shown in FIG. 5, because the background template is used to extract the foreground image from the input image, the remaining area of the updated background template, which is updated by filling the overlap area shown in FIG. 3 ,does not need to be filled.

According to some embodiments, the filling of the overlap area of the second background template based on the corresponding overlap area of the input image may be based on an image feature (e.g., a color feature, a texture feature, and/or a shape feature) of the overlap area of the input image. For example, the part of the input image corresponding to the overlap area may be filled directly to the overlap area in the second background template. As another example, the overlap area in the second background template may be filled based on an image feature of the part of the input image corresponding to the overlap area. As another example, the overlap area in the second background template may be filled with image data from the input image (corresponding to the overlap area) that is subjected to image processing (e.g., image enhancement processing, image compression processing, etc.).

Furthermore, although some embodiments may involve performing an update of the second background template based on the second similarity being less than a second threshold, the embodiments are not limited thereto. It is also possible to directly update the first background template based on the input image (for example, based on a user input), or to update the first background template and/or the second background template according to a predetermined rule (for example, periodically), and the details of the above processing for updating the second background template can be applied to any situation of updating the background template. The means by which the overlap area of the background template is filled with image data that originates from the input image may vary.

Furthermore, according to some embodiments, the second threshold may be a preset empirical value. When the second similarity is greater than or equal to the second threshold, it can be considered as a high similarity, and when the second similarity is less than the second threshold, it can be considered as a low similarity. For example, the second threshold may be set to 0.35.

Returning to refer to FIG. 2, according to some embodiments, based on the second similarity being less than the second threshold, the background template for the input image is generated according to the input image. That is, when the second similarity is low, it may mean that the first background template is completely unavailable or that the alignment processing failed; in such cases a new background template may need to be generated.

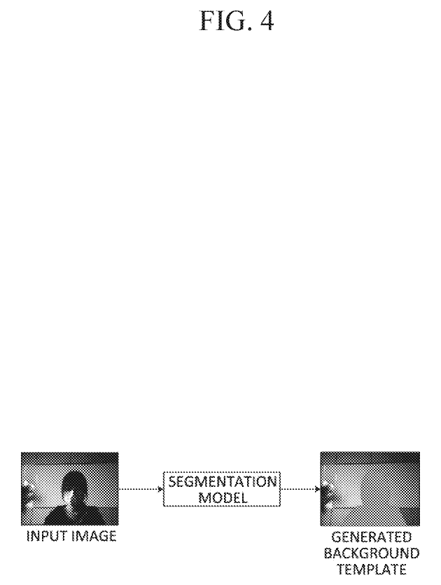

FIG. 4 illustrates an example of generating a background template according to some embodiments.

According to some embodiments, a background area of the input image is obtained by segmenting the input image using a segmentation model (e.g., an instance segmentation model).

For example, the instance segmentation model may be used to determine, from the input image, a target object area in the input image that is associated with a target object (e.g., a foreground segment) and a background area that is not associated with the target object.

According to some embodiments, when the target object area in the input image has been determined/detected, that target object area in the input image is set as an area-to-be-filled (a masked area), and the area-to-be-filled of the input image is determined as the background template for the input image. For example, with reference to FIG. 4, a target object area associated with a person in the input image is set as an area-to-be-filled, the area having the set image feature as described above, thereby obtaining/generating the background template.

According to some embodiments, the finally obtained background template may be applied to the input image and/or other images among those possibly associated with the input image. In other words, since the input images included in the video may have the same or similar background, the same background template may be applied for a set of similar input images to save storage and computational resources.

By various operations as described above, it is able to determine the background template for the input image with a high accuracy based on the input image and/or a preset background template. A foreground image may then be accurately extracted from the input image by using the finally determined background template.

Returning to FIG. 1, at step S140, a foreground image is extracted from the input image based on the background template for the input image. The step S140 of extracting the foreground image is described with reference to FIG. 5.

FIG. 5 illustrates an example processing of extracting a foreground image according to some embodiments.

According to some embodiments, referring to FIG. 5, a difference image of the input image may be obtained based on the input image and the background template. Specifically, for example, the difference image may be obtained by subtracting the background template for the input image from the input image.

A difference image may be generated by, for each pixel at a same location in the input image and the background template, obtaining a value of a pixel at the corresponding location in the difference image by subtraction of grayscale values of corresponding two pixels in the input image and the background template, respectively. In some implementations, for each pixel at a same location in the input image and the background template, whether the two pixels are similar or not may be determined by calculating a cosine similarity of the corresponding two pixels, and the similarity may be converted to a value for a pixel at the corresponding location in the difference image. The manner for measuring the difference between the input image and the background template may include, but is not limited to, other similarity calculation algorithms, image comparison algorithms, and the like.

After obtaining the difference image, a mask image may be obtained based on the values of the pixels in the difference image.

Specifically, for each pixel in the difference image, based on a result of comparing the value of the pixel with a third threshold, a value is assigned to each corresponding pixel in the mask image, to obtain an initial mask image (one preceding morphological processing, described shortly).

For example, based on the value of a first pixel in the difference image being greater than or equal to the third threshold, it may be determined that a similarity between pixels in the input image and the background template at the same location as the first pixel is low, and the value of the pixel in the mask image at the same location as the first pixel is set to 1 (i.e., the corresponding grayscale value is 255). For example, pixels of a white area in the mask image in FIG. 5 are assigned values of 1. An area in which pixels have values of 1 may be considered to be an area of interest.

For example, based on a value of a second pixel in the difference image being less than the third threshold, it may be determined that the similarity between the pixels in the input image and the background template at the same location as the second pixel is high, and the value (i.e., the grayscale value) of the pixel in the mask image at the same location as the second pixel may be accordingly set to 0 (i.e., the corresponding grayscale value is 0). For example, pixels of a black area in the mask image in FIG. 5 is assigned values of 0.

Thus, an initial mask image may be obtained, by assigning values to respective pixels of the mask image based on the difference image, respectively.

According to some embodiments, the third threshold may be a preset empirical value. When a value of a pixel in the difference image is greater than or equal to the third threshold, it can be considered that the similarity between the corresponding pixels in the input image and the background template is relatively low, and when a value of a pixel in the difference image is less than the third threshold, it can be considered that the similarity between the corresponding pixels in the input image and the background template is relatively high. For example, the third threshold may be set to 20.

However, the obtained initial mask image may have a small void due to an unavoidable minor error during the image processing. In this regard, according to an embodiment, a morphological processing may also be performed on the initial mask image to obtain a mask image of which the void is filled up. Specifically, the void in the initial mask image may be filled up by erosion and/or expansion processing in the morphological processing. Other image quality optimization processing for the image may also/alternatively be performed; the embodiments are not limited thereto.

By the morphological processing, some minor voids in the mask image may be eliminated to avoid deterioration of image quality due to minor errors.

In some implementations, after obtaining the mask image, referring to FIG. 5, a foreground image is obtained based on the input image and the mask image. The foreground image may be obtained by multiplying a pixel matrix of the input image with a pixel matrix of the mask image. Specifically, since the pixels of the area of interest in the mask image have values of 1 and the pixels of the other areas have values of 0, an image including only the area of interest, i.e., a foreground image, may be obtained from the input image by the multiplication operation.

In addition, in order to achieve target detection, a large-scale model may be used in the image processing method. According to some embodiments, the image processing method may further include: detecting whether a predetermined object (e.g., another target object) is present in the input image by using a target detection model (e.g., a large-scale target detection model); in response to detecting the predetermined object in the input image, the image processing for the input image may end, and the input image re-acquired (a new input image is obtained) and the above image processing method may be performed on the new input image. That is, target detection for the predetermined object may be performed using the large-scale model to detect whether a trigger condition for stopping the image processing is met. For example, when the predetermined object (such as, a camera) is detected, there may be a risk of leakage of information about the current environment, the image processing may be ended, and the user may be prompted to re-acquire the input image. In this case, the user may choose to remove the predetermined object and re-perform the image processing method.

Here, for the sake of information security and to reduce the computational burden of the large-scale model, the target detection may be performed on the input image based on a predetermined rule (e.g., at predetermined time intervals, for every predetermined number of input images) or in response to a user input before performing the above image processing method, instead of performing the target detection on all input images. Specifically, in practical applications, a computer vision technology may be used to determine whether the predetermined object is present in the environment, e.g., to determine whether an object involving security (such as, a camera) is present. The safety of the environment can be ensured by accurate detection of the predetermined object using the large-scale target detection model. Therefore, in the image processing method, the large-scale model may be used to detect the presence of the predetermined object, and the image processing can be stopped once the predetermined object involving the security is detected, which can accurately identify the predetermined object, and the processing can be stopped to avoid the risk of privacy leakage and to conserve computational resources.

Here, although the target detection using the large-scale target detection model is described as being performed prior to the image processing method, the embodiments are not limited thereto, and target detection may also be performed simultaneously with the image processing method or after performing the image processing method.

The foreground image obtained from the input image can be accurately obtained by the image processing method as described above, and the above image processing method can also be applied in the target detection method.

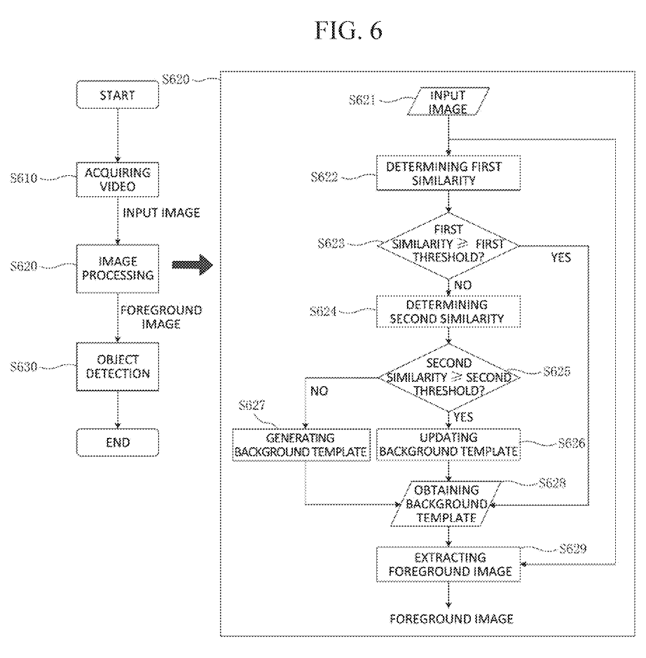

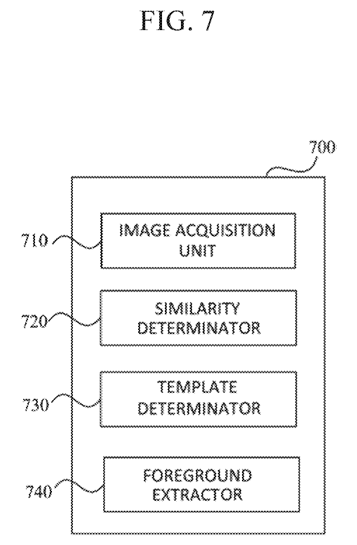

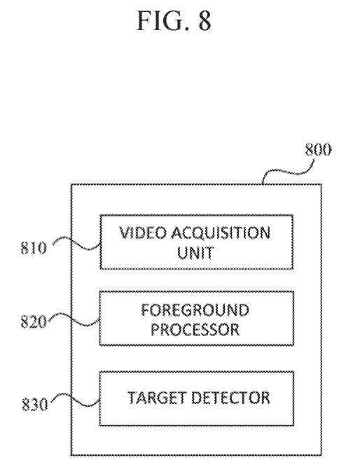

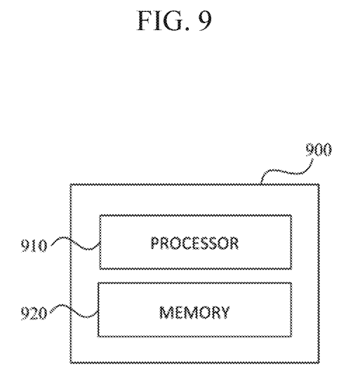

FIG. 6 illustrates a target detection method according to some embodiments.

According to some embodiments, at step S610, a video including input images is acquired. The manner of acquiring the video may be similar to the manner of acquiring the video as described above with reference to step S110.

At step S620, for the input images, the image processing method described with reference to FIGS. 1 to 5 may be performed sequentially. That is, for each of the input images, the image processing method as described above is performed to obtain foreground images for the input images, respectively. The step S620 is described below with reference to the right block of FIG. 6.

At step S621, the input image is acquired.

At step S622, a first similarity between the acquired input image and a preset background template is determined.

At step S623, whether the first similarity is greater than or equal to the first threshold is determined.

When the first similarity is greater than or equal to the first threshold, at step S628, the preset background template is directly obtained as the background template for the input image (e.g., without updating the preset background template).

When the first similarity is less than the first threshold, at step S624, the input image is aligned with the preset background template to determine a second similarity between the input image and the aligned background template.

At step S625, whether the second similarity is greater than or equal to a second threshold is determined.

When the second similarity is greater than or equal to the second threshold, at step S626, the aligned background template is updated, and at step S628, the updated background template is obtained as the background template for the input image.

When the second similarity is less than the second threshold, at step S627, a new background template is generated, and at step S628, the generated background template is obtained as the background template for the input image.

The step S620 as a whole corresponds to the steps S110, S120, and S130. Specifically, the details of the step S110 are applicable to the step S621, the details of the step S120 are applicable to the step S622, and the details of the step S130 are applicable to the steps S623 to S628.

When the background template had been obtained, at step S629, a foreground image is extracted from the input image using the background template, wherein the foreground image may be used for subsequent target detection. The step S629 corresponds to the step S140, and specific details of the step S140 may be applicable to the step S629 and are not repeated herein.

When the foreground image is obtained at step S620, target detection may be performed on the extracted foreground image. The foreground image obtained using the image processing method may be used as an input to a target detection model in the target detection step. Operations of step S620 may reduce the load on the object detection model by inputting only the foreground image extracted from the input image through preprocessing into the object detection model, so only the foreground image is input to the object detection model.

At step S630, by using a target detection model (e.g., a light-weight target detection model), the target detection is performed on the foreground image obtained by the image processing method at the step S620. Specifically, the target detection model is used to perform target detection regarding the target object in the input image. For example, the target object may be a person, the foreground image substantially containing the person may be obtained by the step S620, and the target detection on the person in the foreground image may be performed in the step S630 to determine a final target detection result.

The light-weight target detection model may include any type of target detection model, such as, but not limited to, a Faster Region-based Convolutional Neural Network (Faster-RCNN) model, a Single Shot MultiBox Detector (SSD) model, a RetinaNet model, a You Only Look Once (YOLO) model, and so on.

Here, since the foreground image containing the target object has been obtained using the described image processing, the need for a modeling capability for the target detection for the foreground image is greatly reduced, and thus the target detection can be achieved using a light-weight target detection model during the target detection processing. Note that the model need not be light-weight; the extracted foreground image may be also be used as an input to a larger object detection model. According to some embodiments, performing the target detection using a low-latency and resource-saving light-weight target detection model may achieve the desired detection accuracy because useless redundant background information has been removed.

According to some embodiments, in addition to detecting the predetermined object in the image processing step at the step S620, the predetermined object (e.g., another target object) may be detected again in the target detection step at the step S630, thereby realizing a double detection of the trigger condition for stopping the image processing (i.e., determining whether the predetermined object is present), so as to reduce any security risk. For example, the predetermined object (i.e., another target object) in the input image may also be target-detected again using the light-weight target detection model, to again determine whether to stop the image processing.

For example, in some embodiments, the predetermined object may be a camera and the target object may be a person, and when the camera is not detected by the step S620 and the foreground image substantially containing the person is obtained, the target detection on the person in the foreground image is performed in the step S630 to determine the final target detection result, and the light-weight target detection model may also be used to perform the target detection on the camera in the input image to again determine whether to stop the image processing.

In some embodiments, the target detection of the predetermined object (i.e., another target object) may be performed using a large-scale model in the image processing method to determine whether a trigger condition for stopping the image processing is met (i.e., to determine whether the predetermined object is present), and the light-weight model may be used in the target detection method to again perform the target detection to obtain a target detection result of the target object. With the target detection method that combines the large-scale model and the light-weight model, the accuracy of target detection can be greatly improved while introducing a small amount of latency.

Based on the result of testing the target detection method, the detection accuracy of the target detection method according to the some embodiments may be close to the detection accuracy of large-scale models in the target detection field, and the latency is close to the latency of a light-weight model in the target detection field, and thus, an optimal balancing of the accuracy and the latency can be achieved, which can substantially improve accuracy while bringing about a lesser delay increasement.

Following is a description of an image processing device for performing the above image processing method and a target detection device for performing the above target detection method.

FIG. 7 illustrates a structure of an image processing device according to some embodiments.

According to some embodiments, the image processing device 700 may include an image acquisition unit 710, a similarity determinator 720, a template determinator 730, and a foreground extractor 740.

Specifically, the image acquisition unit 710 may be configured to acquire an input image, the similarity determinator 720 may be configured to determine a first similarity between the input image and a preset first background template, the template determinator 730 may be configured to determine a background template for the input image based on the first similarity, and the foreground extractor 740 may be configured to extract a foreground image from the input image based on the background template for the input image.

That is, the image acquisition unit 710 may perform an operation corresponding to the step S110 of the image processing method as described above with reference to FIG. 1, the similarity determinator 720 may perform an operation corresponding to the step S120 of the image processing method as described above with reference to FIGS. 1 and 2, the template determinator 730 may perform an operation corresponding to the step S130 of the image processing method as described above with reference to FIGS. 1 to 4, and the foreground extractor 740 may perform an operation corresponding to step S140 of the image processing method as described above with reference to FIGS. 1 and 5.

According to some embodiments, the template determinator 730 may be configured to determine the background template for the input image based on the first similarity by: based on the first similarity being greater than or equal to a first threshold, determining the first background template as the background template for the input image; and based on the first similarity being less than the first threshold, determining the background template for the input image according to the input image and the first background template.

According to some embodiments, the template determinator 730 may be configured to, based on the first similarity being less than the first threshold, determine the background template for the input image according to the input image and the first background template by: aligning the input image with the first background template, to obtain an aligned second background template; determining a second similarity between the input image and the second background template; based on the second similarity being greater than or equal to a second threshold, updating the first background template according to the input image, and determining the updated first background template as the background template for the input image; and based on the second similarity being less than the second threshold, generating the background template for the input image according to the input image.

According to some embodiments, the template determinator 730 may be configured to, based on the second similarity being greater than or equal to the second threshold, update the first background template according to the input image by: obtaining a background area of the input image by segmenting the input image using a segmentation model; and filling a portion of an area-to-be-filled included in the second background template based on the background area, thus obtaining the updated first background template.

According to some embodiments, the template determinator 730 may be configured to fill the portion of the area-to-be-filled included in the second background template based on the background area, to obtain the updated first background template, by: determining an overlap area between the background area and the area-to-be-filled in the second background template; filling the overlap area in the second background template based on the overlap area in the input image; and determining the second background template of which the overlap area is filled as the updated first background template.

According to some embodiments, the template determinator 730 may be configured to, based on the second similarity being less than the second threshold, generate the background template for the input image according to the input image, by: obtaining a non-background area of the input image by segmenting the input image using a segmentation model; setting the non-background area in the input image as an area-to-be-filled; and determining the input image of which the area-to-be-filled is set, as the background template for the input image.

According to some embodiments, the foreground extractor 740 may be configured to extract the foreground image from the input image based on the background template for the input image by: obtaining a difference image of the input image based on the input image and the background template; obtaining a mask image based on a value of each pixel in the difference image; and obtaining the foreground image based on the input image and the mask image.

According to some embodiments, the background template for the input image includes an area-to-be-filled for extracting the foreground image, and an image feature of the area-to-be-filled is set based on an occurrence frequency of the image feature, which is different from an image feature of an area in the background template other than the area-to-be-filled.

According to some embodiments, the image processing device 700 may further include an object detector. The object detector may be configured to: detect whether a predetermined object is present in the input image by using a target detection model; and in response to detecting the predetermined object in the input image, stop the image processing for the input image and re-acquire the input image.

The specific means by which each unit of the image processing device 700 performs its operations are described above with reference to the related image processing method.

FIG. 8 illustrates a structure of a target detection device according to some embodiments.

According to some embodiments, the target detection device 800 may include a video acquisition unit 810, a foreground processor 820, and a target detector 830.

Specifically, the video acquisition unit 810 may be configured to acquire a video including input images, the foreground processor 820 may be configured to, for the input images, sequentially perform the image processing method as described above, and the target detector 830 may be configured to, by using a target detection model, perform a target detection on the foreground images obtained by the image processing method.

That is, the video acquisition unit 810 may perform an operation corresponding to the step S610 of the target detection method as described above with reference to FIG. 6, the foreground processor 820 may perform an operation corresponding to the step S620 of the target detection method as described above with reference to FIG. 6 or an operation corresponding to the image processing method as described above with reference to FIGS. 1 and 2, and the target detector 830 may perform an operation corresponding to the step S630 of the target detection method as described above with reference to FIG. 6.

The specific means by which each unit of the target detection device 800 in the above embodiments performs its operations are with reference to the related target detection method.

Furthermore, it should be understood that individual units in the image processing device 700 and the target detection device 800 according to some embodiments may be implemented with hardware components and/or software components. Those skilled in the art may, for example, use field programmable gate arrays (FPGAs) or application-specific integrated circuits (ASICs) to implement the individual units, depending on the processing or operations performed by the defined individual units.

According to some embodiments, there is also provided an electronic apparatus. FIG. 9 illustrates a structure of an electronic apparatus according to some embodiments.

According to some embodiments, the electronic apparatus 900 may include at least one processor 910 and at least one memory 920 storing computer-executable instructions. The computer-executable instructions, when being executed by the at least one processor 910, cause the at least one processor 910 to perform the image processing method or the target detection method as described above.

According to some embodiments, the electronic apparatus 900 may be a PC computer, a tablet device, a personal digital assistant, a smartphone, or other apparatuses capable of executing a set of instructions described above. Here, the electronic apparatus 900 does not have to be a single electronic apparatus 900, but can also be any collection of apparatuses or circuits capable of executing the above instructions (or the set of instructions) individually or jointly. The electronic apparatus 900 may also be part of an integrated control system or system manager, or a portable electronic apparatus that may be configured to be interconnected with an interface locally or remotely (e.g., via wireless transmission).

In the electronic apparatus 900, the processor 910 may be/include a central processing unit (CPU), a graphics processing unit (GPU), a programmable logic device, a dedicated processor system, a microcontroller, and/or a microprocessor. By way of example and not limitation, the processor 910 may also be/include an analog processor, a digital processor, a microprocessor, a multi-core processor, a processor array, a network processor, and/or the like.

The processor 910 may execute instructions or code stored in memory 920, and the memory 920 may also store data. The instructions and data may also be transmitted and received over a network via a network interface device, wherein the network interface device may utilize any known transmission protocol.

The memory 920 may be integrated with the processor 910, for example, by arranging RAM or flash memory within an integrated circuit microprocessor. In addition, the memory 920 may include a separate device, such as, an external disk drive, a storage array, or other storage device that may be used by any database system. The memory 920 and the processor 910 may be operationally coupled or may communicate with each other, for example, via I/O ports, network connections, etc., enabling the processor 910 to read files stored in the memory 920.

In addition, the electronic apparatus 900 may further include a display (e.g., a liquid crystal display) and a user interaction interface (e.g., a keyboard, a mouse, a touch input device, etc.). Components of the electronic apparatus 900 may be connected to each other via a bus and/or network.

According to some embodiments, there is also provided a computer-readable storage medium, wherein instructions in the computer-readable storage medium, when being executed by at least one processor, cause the at least one processor to perform the image processing method or the target detection method as described above.

According to an some embodiments, examples of computer-readable storage medium include: a read-only memory (ROM), a random-access programmable read-only memory (PROM), an electrically erasable programmable read-only memory (EEPROM), random-access memory (RAM), a dynamic random-access memory (DRAM), a static random-access memory (SRAM), a flash memory, a nonvolatile memory, a CD-ROM, a CD-R, a CD+R, a CD-RW, a CD+RW, a DVD-ROM, a DVD-R, a DVD+R, a DVD-RW, a DVD+RW, a DVD-RAM, a BD-ROM, a BD-R, a BD-R LTH, a BD-RE, a Blu-ray or optical disk memory, a hard disk drive (HDD), a solid-state drive ( SSD), a card memory (such as, a multimedia card, a Secure Digital (SD) card, or an Extreme Digital (XD) card), a magnetic tape, a floppy disk, a magneto-optical data storage device, an optical data storage device, a hard disk, a solid state disk, and any other device, the any other device is configured to store a computer program, as well as any associated data, data files, and data structures, in a non-transitory manner, and to provide the computer program and any associated data, data files and data structures to a processor or computer, to cause the processor or computer to execute the computer program. The computer program in the above computer-readable storage medium may be executed in an environment deployed in an electronic apparatus such as a client, a host, a proxy device, a server, etc. Furthermore, in one example, the computer program and any associated data, data files, and data structures are distributed across a networked computer system, such that the computer program and any associated data, data files, and data structures are stored, accessed, and executed in a distributed manner through one or more processors or computers.

The computing apparatuses, the electronic devices, the processors, the memories, the image sensors, the displays, the information output system and hardware, the storage devices, and other apparatuses, devices, units, modules, and components described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-9 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method for image processing performed by one or more processors, comprising:
acquiring an input image;
determining a first similarity between the input image and a preset first background template;
determining a background template for the input image based on the first similarity; and
extracting a foreground image from the input image based on the background template for the input image.

2. The method of claim 1,
wherein the determining the background template for the input image based on the first similarity comprises, based on comparing the first similarity to a first threshold, selecting between:
when the first similarity is greater than or equal to a first threshold, determining the first background template as the background template for the input image; and
when the first similarity is less than the first threshold, determining the background template for the input image according to the input image and the first background template.

3. The method of claim 2,
wherein, based on the first similarity being less than the first threshold, the determining the background template for the input image according to the input image and the first background template comprises:
aligning the first background template with the input image, to obtain an second background template;
determining a second similarity between the input image and the second background template, and based thereon selecting between:
when the second similarity is greater than or equal to a second threshold, updating the first background template according to the input image, and determining the updated first background template as the background template for the input image; and
when the second similarity is less than the second threshold, generating the background template for the input image according to the input image.

4. The method of claim 3,
wherein, based on the second similarity being greater than or equal to the second threshold, the updating the first background template according to the input image comprises:
obtaining a background area of the input image by segmenting the input image using a segmentation model; and
filling a portion of an area-to-be-filled included in the second background template based on the background area, to obtain the updated first background template.

5. The method of claim 4,
wherein the filling the portion of the area-to-be-filled included in the second background template based on the background area, to obtain the updated first background template, comprises:
determining an overlap area between the background area and the area-to-be-filled in the second background template;
filling at least a portion of the overlap area in the second background template based on a portion corresponding to the overlap area in the input image; and
determining the second background template of which the at least a portion of the overlap area is filled, as the updated first background template.

6. The method of claim 3,
wherein, generating the background template for the input image according to the input image comprises, based on the second similarity being less than the second threshold:
obtaining a non-background area of the input image by segmenting the input image using a segmentation model;
setting the non-background area in the input image as an area-to-be-filled; and
determining the input image of which the area-to-be-filled is set, as the background template for the input image.

7. The method of claim 1,
wherein the extracting the foreground image from the input image based on the background template for the input image comprises:
obtaining a difference image of the input image based a difference between the input image and the background template;
obtaining a mask image based on values of respective pixels in the difference image; and
obtaining the foreground image based on the input image and the mask image.

8. The method of claim 1,
wherein the background template for the input image includes a first area-to-be-filled for extracting the foreground image,
wherein a first image feature of the first area is set based on an occurrence frequency of the first image feature and the first image feature is different from a second image feature of a second area in the background template other than the first area.

9. A target detection method performed by one or more processors, the method comprising:
acquiring a video including input images;
determining first similarities between the input images and respective preset first background templates;
determining background templates for the respective input images based on the respective first similarities;
extracting foreground images from the respective input images based on the respective background templates for the respective input images; and
using a target detection model to perform target detection on the extracted foreground images.

10. A device for image processing, comprising:
one or more processors comprising processing circuitry; and
one or more memories storing code or instructions configured to, when executed by the one or more processors, cause the device to:
acquire an input image;
determine a first similarity between the input image and a preset first background template;
determine a background template for the input image based on the first similarity; and
extract a foreground image from the input image based on the background template for the input image.

11. The device of claim 10,
the determining the background template for the input image based on the first similarity is performed by, based on comparing the first similarity to a first threshold, selecting between:
when the first similarity is greater than or equal to a first threshold, determining the first background template as the background template for the input image; and
when the first similarity is less than the first threshold, determining the background template for the input image according to the input image and the first background template.

12. The image processing device of claim 11,
wherein the instructions or code are further configured to cause the device to, based on the first similarity being less than the first threshold, determine the background template for the input image according to the input image and the first background template by:
aligning the first background template with the input image, to obtain an second background template;
determining a second similarity between the input image and the second background template, and based thereon selecting between:
when the second similarity is greater than or equal to a second threshold, updating the first background template according to the input image, and determining the updated first background template as the background template for the input image; and
when the second similarity is less than the second threshold, generating the background template for the input image according to the input image.

13. The image processing device of claim 12,
wherein the instructions or code are configured to cause the device to, based on the second similarity being greater than or equal to the second threshold, update the first background template according to the input image by:
obtaining a background area of the input image by segmenting the input image using a segmentation model; and
filling a portion of an area-to-be-filled included in the second background template based on the background area, to obtain the updated first background template.

14. The image processing device of claim 13,
wherein the instructions or code are further configured to cause the device to fill the portion of the area-to-be-filled included in the second background template based on the background area, and obtain the updated first background template, by:
determining an overlap area between the background area and the area-to-be-filled in the second background template;
filling at least a portion of the overlap area included in the second background template based on a portion corresponding to the overlap area in the input image; and
determining the second background template of which the at least a portion of the overlap area is filled, as the updated first background template.

15. The image processing device of claim 12,
wherein the instructions or code are further configured to, based on the second similarity being less than the second threshold, generate the background template for the input image according to the input image, by:
obtaining a non-background area of the input image by segmenting the input image using a segmentation model;
setting the non-background area in the input image as an area-to-be-filled; and
determining the input image of which the area-to-be-filled is set, as the background template for the input image.

16. The image processing device of claim 10,
wherein the instructions or code are further configured to cause the device to extract the foreground image from the input image based on the background template for the input image by:
obtaining a difference image of the input image based on a difference between the input image and the background template;
obtaining a mask image based on values of respective each pixels in the difference image; and
obtaining the foreground image based on the input image and the mask image.

17. The image processing device of claim 10,
wherein the background template for the input image includes a first area-to-be-filled for extracting the foreground image, wherein a first image feature of the first area is set based on an occurrence frequency of the first image feature that is different from a second image feature of a second area in the background template other than the first area.
